(19) United States
(12) Patent Application Publication
(10) Pub. No.: US 2020/0094456 A1
(43) Pub. Date: Mar. 26, 2020

(54) METHOD AND APPARATUS FOR OVERMOLDING GUTTA-PERCHA ONTO CARRIERS

(71) Applicant: DENTSPLY SIRONA Inc., York, PA (US)

(72) Inventors: Geoffrey Kamau NDUNGU, Johnson City, TN (US); Christopher Michael GLADSON, Kingsport, TN (US)

(73) Assignee: DENTSPLY SIRONA Inc., York, PA (US)

(21) Appl. No.: 16/137,958

(22) Filed: Sep. 21, 2018

(51) Int. Cl. B29C 45/16; B29C 45/14

(52) U.S. Cl. CPC B29C 45/1635; B29K 2007/00; B29C 45/14426

(57) ABSTRACT

An apparatus and method for concentrically overmolding Gutta-Percha onto a carrier. A shape, structure and dimensions of gutta-percha may be configured into cavities of a mold having more retractable pins for concentrically overmolding the gutta-percha onto one or more carriers. The apparatus may preferably be automated/self-driven to concentrically overmold gutta-percha onto the carriers in multiple stages and cycles.

### FIELD OF THE INVENTION

The present application relates generally to carriers for root canal obturation, and, more particularly, to a self-driven apparatus and method for concentrically overmolding Gutta-Percha onto a carrier.

### BACKGROUND OF THE INVENTION

During fabrication of dental products like carriers, silicon blocks with cavities having the shape of the dental product may be used wherein overmolding material may be manually inserted into the cavities of the silicon block. The silicon block may then be heated for a time period, for example, several hours for gutta-percha, to melt the material into the cavities. Carriers may subsequently be manually inserted into the silicon block and held in place with for example aluminum blocks so that the molten gutta-percha may encapsulate a part of the inserted carrier. The silicon block may then be cooled down and the carrier removed after the molten gutta-percha has solidified around the carrier. A problem with this method however is that the manual process is time consuming and expensive. Moreover multiple people may be needed for this process. Further the process is prone to human errors and in many cases, the gutta-percha may not be overmolded concentrically around the carrier due to the molten gutta-percha taking a path of least resistance and flowing non-uniformly in the mold.

U.S. Pat. No. 5,147,657 discloses a retractable pin and an injection mold machine for golf balls wherein the mold positions gates at each pole of each mold cavity making balancing less critical and reducing shifting of cores during molding operations.

U.S. Pat. No. 6,129,881 discloses a retractable sleeve for a golf ball injection mold, wherein the retractable sleeve may be used to fabricate a golf ball cover or intermediate layer with improved durability in a high volume production environment.

U.S. Pat. No. 7,223,085 provides a mold and method for forming a golf ball with at least a core. The mold and method may comprise or use members with projections for forming multiple dimples on the core. The members may be retractable pins or sleeves or vent pins. In the case of the retractable pins, sets of pins with multiple dimple projections on the ends thereof are used to center the golf ball core within the mold. The members may also have circular or non-circular cross-sections so that the dimple-forming projections can conform to any dimple pattern.

US Patent No. US20010048180 teaches a device including first and second hemispherical mold halves that may form an interior cavity where an injection molding process may occur. A plurality of retractable pins may be used to support a core within the mold cavity. The first and second mold halves may further include a plurality of sub gates. Which may be connected to a runner system for delivery of a fluid stock material into a void of the cavity.

U.S. Pat. Nos. 5,201,523, 6,093,360, 3,919,774, 6,441,741, 2,301,338 and 5,240,397 disclose other methods which may be use in injection molding processes.

### SUMMARY OF THE INVENTION

Existing limitations associated with the foregoing, as well as other limitations, may be overcome by a method and apparatus for concentrically overmolding gutta-percha onto carriers. Herein, to prevent excessive stress on the carriers 10 during overmolding, the production cycle may be divided into one or more stages with corresponding retractable pins of the stages such that one or more overmolded carriers may be produced to save time and increase accuracy and repeatability of the cycles. Moreover the apparatus may also be configured to injection mold the one or more carriers.

In an aspect of the present invention a method for concentrically overmolding one or more gutta-percha materials onto one or more corresponding gutta-percha carriers in stages is disclosed, the method comprising: for each stage: obtaining desired/predetermined dimensions of one or more gutta-percha materials (and/or layers of gutta-percha materials) to be overmolded onto one or more corresponding gutta-percha carriers; altering a size of cavities of one or more corresponding molds based on the obtained desired dimensions; centrally positioning the one or more corresponding gutta-percha carriers in the one or more corresponding molds using one or more corresponding retractable pins such that the one or more corresponding gutta-percha carriers are evenly spaced or substantially evenly spaced from inner walls of said cavities; and concentrically overmolding the one or more gutta-percha onto the one or more corresponding gutta-percha carriers.

In another aspect of the present invention, the method comprises one or more of the following features: (i) wherein the number of stages is based on characteristics of the corresponding gutta-percha carriers, (ii) wherein the characteristics include length, thickness and/or strength, (iii) wherein a diameter of gutta-percha overmolded at a tip of the one or more gutta-percha carriers is about 0.09 mm, (iv) wherein the method further comprises altering a size of cavities of one or more corresponding molds through (a) retractably and/or (b) manually changing the molds.

In another aspect of the present invention, an apparatus for concentrically overmolding one or more gutta-percha onto one or more corresponding gutta-percha carriers in stages is disclosed, the apparatus comprising: one or more corresponding molds configured to receive one or more corresponding gutta-percha carriers; one or more retractable pins configured to centrally position the one or more corresponding gutta-percha carriers in one or more corresponding cavities of the one or more corresponding molds such that the one or more corresponding gutta-percha carriers are evenly spaced or substantially evenly spaced from inner walls of the one or more corresponding cavities; and a processor configured for each stage to: obtain desired dimensions of the one or more gutta-percha to be overmolded onto the one or more corresponding gutta-percha carriers; and concentrically overmold the one or more gutta-percha onto the one or more corresponding gutta-percha carriers.

In another aspect herein, the apparatus includes one or more of the elements: (i) wherein the number of stages is based on characteristics of the one or more corresponding gutta-percha carriers, (ii) wherein the characteristics include length, thickness and/or strength, (iii) wherein the one or more corresponding molds has a horseshoe-shaped cavity at one end of the one or more corresponding molds for overmolding gutta-percha onto a tip of the one or more corresponding gutta-percha carriers such that pressure on said tip of the one or more corresponding gutta-percha carriers is minimized, (iv) wherein the one or more corresponding molds is changeable, (v) wherein the one or more corresponding molds includes a retractable insert, (vi) wherein the apparatus further comprises one or more corresponding gates at each stage configured to direct molten gutta-percha into the one or more corresponding cavities to overmold the one or more gutta-percha, (vii) wherein the one or more retractable pins are configured to be concentric around the one or more corresponding molds such that the one or more corresponding gutta-percha carriers are positioned centrally.

In yet another aspect herein, the apparatus the apparatus includes: one or more corresponding molds configured to receive one or more corresponding gutta-percha carriers; one or more retractable pins configured to centrally position the one or more corresponding gutta-percha carriers in one or more corresponding cavities of the one or more corresponding molds such that the one or more corresponding gutta-percha carriers are evenly spaced or substantially evenly spaced from inner walls of the one or more corresponding cavities; wherein the one or more corresponding molds is constructed to seal off a predetermined portion of the one or more corresponding gutta-percha carriers such that an exposed portion of the one or more corresponding gutta-percha carriers is concentrically overmolded.

Further features and advantages, as well as the structure and operation of various embodiments herein, are described in detail below with reference to the accompanying drawings.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein and wherein:

FIG. 1 illustrates a carrier with gutta-percha overmolded concentrically around a portion of the carrier.

FIG. 2 shows an embodiment of the inventive mold having a cavity to receive a carrier.

FIG. 3 illustrates an embodiment of the carrier and gutta-percha molding stages using an apparatus according to an embodiment of the present invention.

FIG. 3A illustrates a first stage of the carrier and gutta-percha molding process according to an embodiment of the present invention.

FIG. 3B illustrates a second stage of the carrier and gutta-percha molding process according to an embodiment of the present invention.

FIG. 3C illustrates a third stage of the carrier and gutta-percha molding process according to an embodiment of the present invention.

FIG. 3D illustrates a fourth stage of the carrier and gutta-percha molding process according to an embodiment of the present invention.

FIG. 4 shows another embodiment of the inventive mold according to an embodiment of the present invention.

FIG. 5 shows an enlarged view of a tip of an overmolded gutta-percha according to another embodiment of the present invention.

FIG. 6 illustrates another mold according to the present invention.

FIG. 7 is a perspective view showing one or more retractable pin operably engaging a carrier.

FIG. 8 illustrates a computer system of the apparatus.

Different ones of the Figures may have at least some reference numerals that are the same in order to identify the same components, although a detailed description of each such component may not be provided below with respect to each Figure.

### DETAILED DESCRIPTION OF THE INVENTION

In accordance with example aspects described herein a method and apparatus may be provided wherein a shape, structure and dimensions of gutta-percha may be configured into cavities of a mold having one or more retractable pins 22 for concentrically overmolding the gutta-percha 11 onto one or more carriers 10. Herein, the apparatus may preferably be automated/self-driven to concentrically overmold one or more gutta-percha materials and/or layers of one or more gutta-percha materials 11 onto one or more carriers 10 for dental use and the retractable pins may be preferably pressure sensitive, though not required. Moreover, to prevent excessive stress on the carriers 10 during overmolding, the production cycle may be divided into one or more stages (e.g. between 1-12 stages, e.g. 4 stages) with corresponding retractable pins such that one or more overmolded carriers may be produced in a short time. In an embodiment herein, a duration for a production cycle may be, for example, between 12-30 seconds (e.g. 24 seconds). In another embodiment, a duration for a stage may be, for example, between 3-9 seconds (e.g. 6 seconds). In a further embodiment a number of carriers being worked on per stage may be, for example, between 1 and 16 carriers 10 (e.g. 8 carriers 10) and a number of finished carriers per production cycle may be, for example, between 1 and 64 carriers 10 (e.g. 32 carriers 10) may be produced per production cycle. The apparatus 14 may also be configured to injection mold the one or more carriers 10.

### Apparatus for Concentrically Molding Gutta-Percha onto Carriers

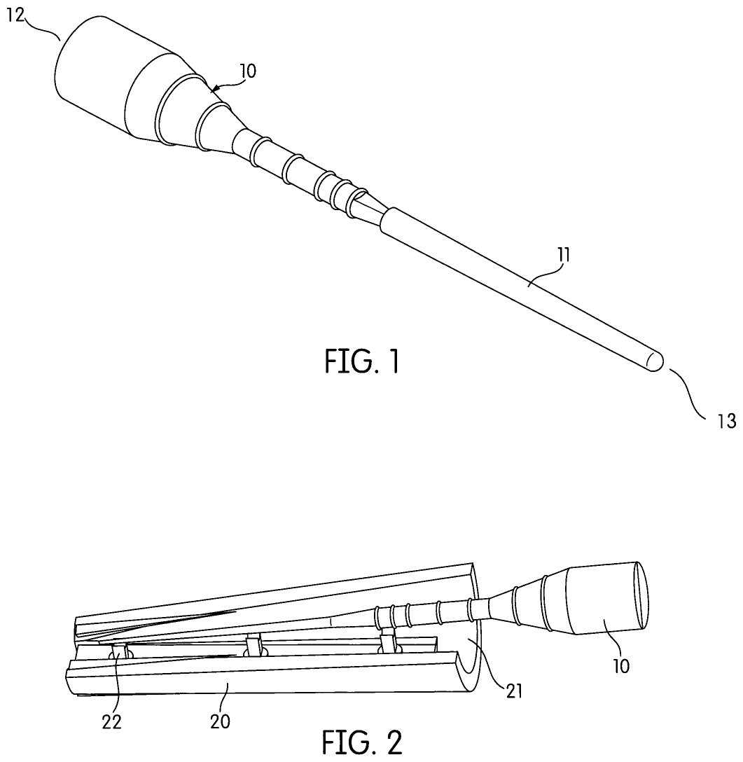

FIG. 1 illustrates an embodiment according to the present invention, including a carrier 10 having a proximal end 12 and a distal end 13. Gutta-percha 11 may be concentrically overmolded around a portion of the distal end 13 of the carrier 10. As shown in FIG. 2, the gutta-percha 11 may be overmolded onto the carrier 10 with a mold 20 having a cavity 21 with a predetermined shape, structure and/or dimensions. In an embodiment herein, the mold may be changeable and/or retractable through such means as mechanical, pneumatic, hydraulic electrical and/or computer controlled means in order to change the shape, structure and/or dimensions of the mold 20. The mold 20 may also include one or more retractable pins for temporarily holding the carrier 10 in a predetermined position during overmolding. Further, the mold 20 may be part of a mold platform/insert 23 of the apparatus 14 wherein the mold platform/insert 23 includes one or more molds 20 having cavities 21 that may be arranged such that one or more gutta-percha materials and/or layers of materials (which may be the same or different) 11 may be automatically overmolded onto one or more carriers 10. In another alternative embodiment, a mold 20 may house retractable inserts (not shown) wherein a shape/size of the mold 20 or cavity 21 of the mold 20 may be altered by retracting the retractable insert. In another embodiment herein, a shape/size of the mold may be altered by changing an internal configuration (preferably a movable internal configuration) of the mold 20.

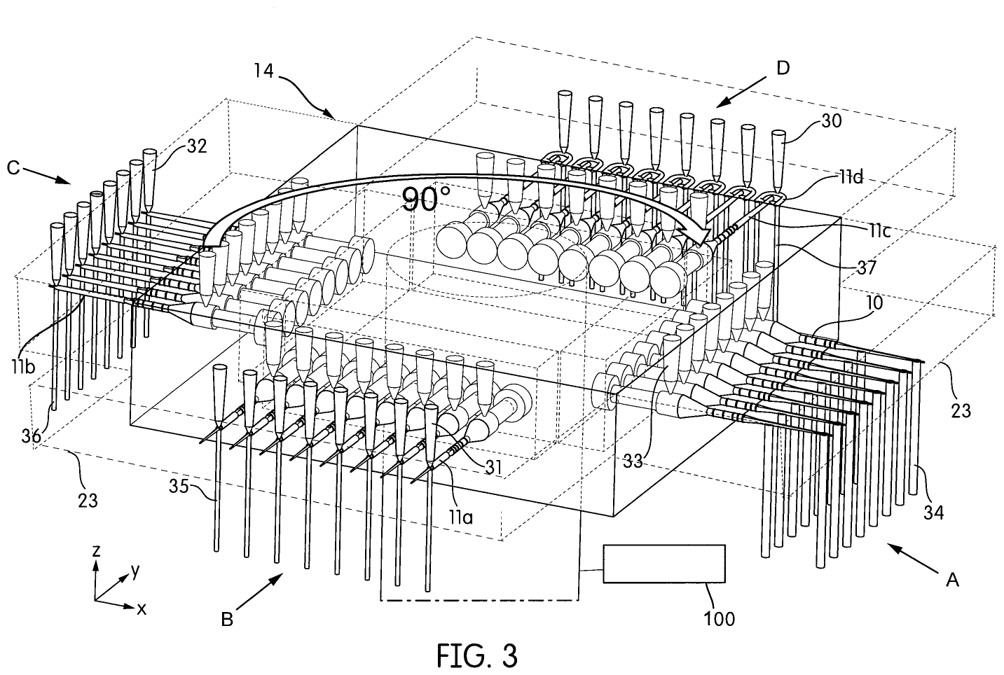

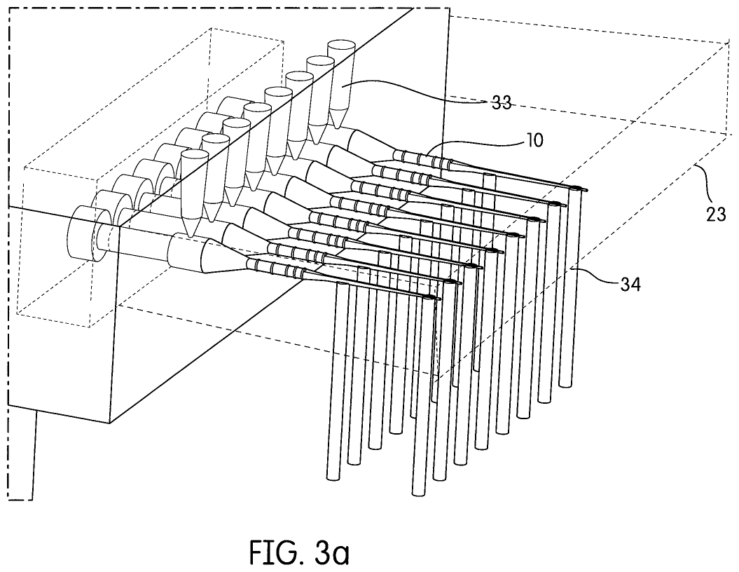

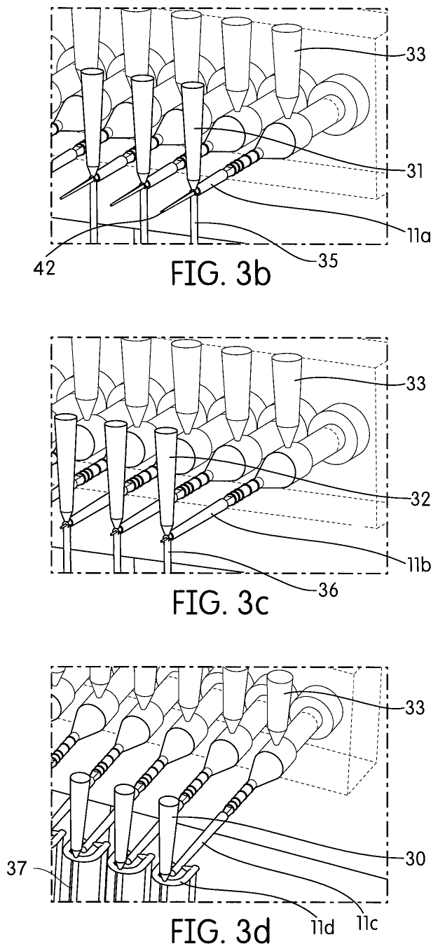

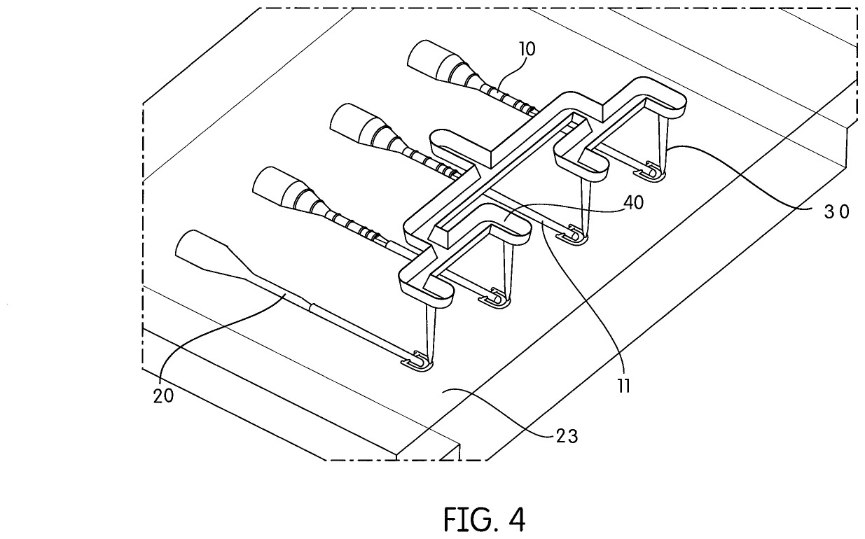

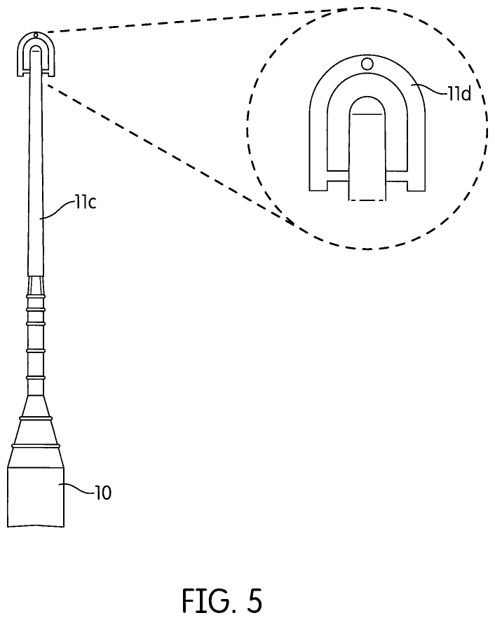

Referring to FIG. 3, an apparatus 14 for concentrically molding one or more gutta-percha 11 onto distal ends 13 of one or more carriers 10 is shown wherein the apparatus may include one or more gates, 30-33, one or more retractable pins, 34-37 and one or more molds 20 (shown in FIG. 2) arranged on a mold platform/insert 23 (shown in FIGS. 3, 3a and 4). However in an alternative embodiment herein, one mold 20, pin 34 and gate 30 maybe used. Moreover, the molds 20 or cavities 21 in the molds 20 may be configured to be changeable (such as through, for example, retractably and/or manually changing the molds 20 or shape of the cavities 21) such that different shapes or sections of the carrier 10 may be injection molded and/or different shapes or sections of the gutta-percha 11 may be overmolded onto the carriers 10.

The apparatus 14 may also include a means (e.g. a mechanically, pneumatically, hydraulically and/or electrically operated means) for turning/rotating the apparatus 14 through a predetermined angle (e.g. 90° about the Z axis or e.g. any angle between 0° and 360° to a stage/location (for example quadrant A, B, C, D) where a predetermined shape or section of the carrier 10 and/or gutta-percha 11 may be injection molded and/or overmolded respectively. A number of stages/locations may be based on characteristics of the carrier to be made such as length, thickness and strength of gutta-percha and or carrier. For example, a longer carrier may require more stages of gutta-percha overmolding than a shorter carrier may require such that the gutta-percha may be overmolded incrementally without putting excessive pressure on the carrier 10 (to minimize pressure exerted on a part or whole of the carrier 10).

A series of gates 30-33 and runners 40 proximal to said gates 30-33 (for example as shown in FIGS. 3 and 4) may be located at each quadrant A,B,C,D and may be configured for molding a portion or whole of the gutta-percha 11 and/or carrier 10 when the apparatus 14 is rotated. In an example embodiment herein, the gates, corresponding runners and corresponding pins may stay at the same quadrant/stage but the carriers and corresponding molds may move to the next quadrant/stage when the apparatus is rotated.

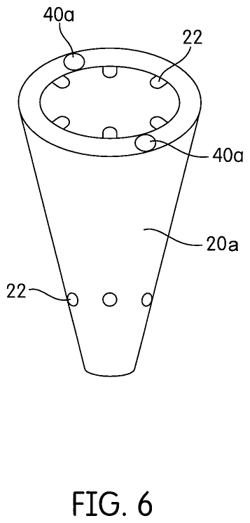

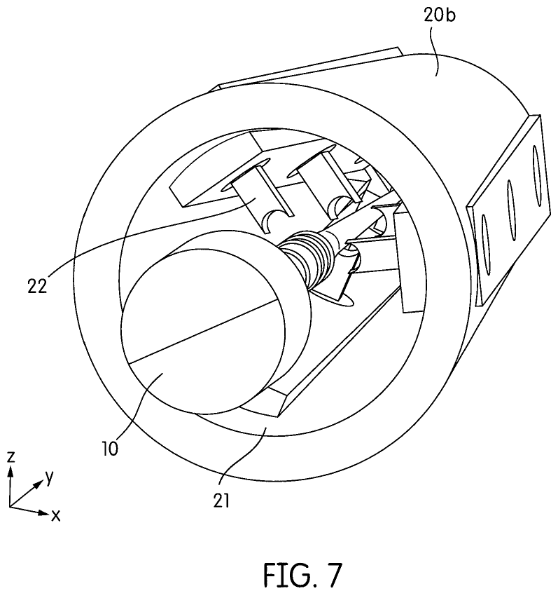

In an embodiment according to the present invention, the mold 20a (as shown in FIG. 6) may include runners 40a through which molten material may flow for molding the gutta-percha 11 and/or carrier 10. In another embodiment, the retractable pins 22 may be configured to be concentric around the mold 20 in order to hold the carrier 10 in a centralized position for overmolding gutta-percha 11 as shown in FIG. 6. In yet another embodiment herein, one or more retractable pins 22 may be configured to be positioned longitudinally along the Y-axis of the mold 20b to centralize the carrier 10 as shown in FIG. 7.

In another embodiment according to the present invention, the apparatus 14 may include a computer system 100 having a processor for providing consistency and repeatability and accuracy in the operation of the apparatus 14. The processor may monitor and controls the processing parameters, including for example the temperature, pressure, injection speed, retraction of retractable pins, and the like. The process control may have a direct impact on the overmolded carrier 10 and may range from a simple relay on/off control to a complex closed-loop control using for example servomotors (not shown) to provide position/speed feedback.

### Computer System for Concentrically Molding Gutta-Percha onto Carriers

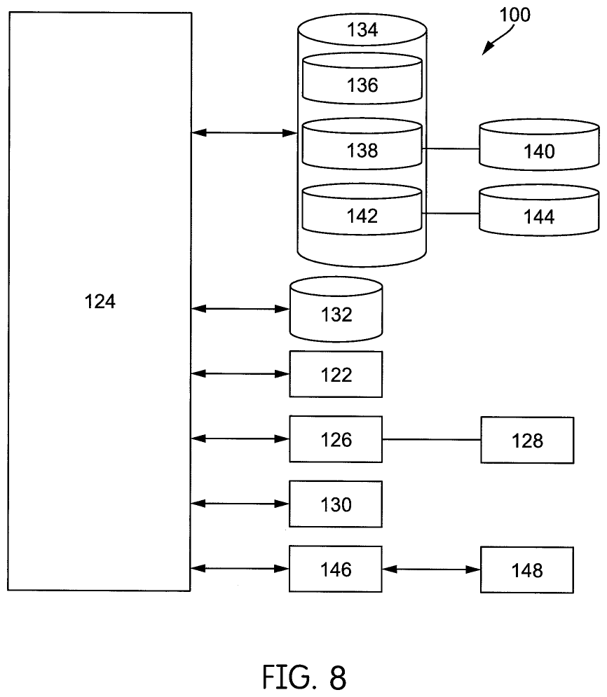

Having described an apparatus 14 for concentrically overmolding gutta-percha 11 onto carriers 10, reference will now be made to FIG. 8, which shows a block diagram of a computer system 100 that may be employed in accordance with at least some of the example embodiments herein. Although various embodiments may be described herein in terms of this exemplary computer system 100, after reading this description, it may become apparent to a person skilled in the relevant art(s) how to implement the disclosure using other computer systems and/or architectures.

The computer system 100 may include at least one computer processor 122 that may be used to ensure a consistency of the quality of injection molded and overmolded parts. Herein parameters such as cavity pressure, rotation speed and temperature of molten material, mold data, quadrant/location data, timing data etc. may be monitored and controlled according to predetermined criteria. Moreover the parameters may be displayed on a display unit 128 of the computer system 100 wherein the parameters may be changeable. The computer processor 122 may include, for example, a central processing unit, a multiple processing unit, an application-specific integrated circuit (“ASIC”), a field programmable gate array (“FPGA”), or the like. The processor 122 may be connected to a communication infrastructure 124 (e.g., a communications bus, or a network). In an embodiment herein, the processor 122 may receive an indication that a production cycle has been initiated by a use and may load instructions from memory or a control panel (display unit 128) concerning a number of overmolded carriers to be produced and may begin the production cycle as described in the methods herein.

A user interface 126 may forward video graphics, text, and other data from the communication infrastructure 124 (or from a frame buffer (not shown)) for display on the display unit 128. For example, the user interface 126 may include a video card with a graphics processing unit.

The computer system 100 may also include an input unit 130 that may be used by a user of the computer system 100 to send information to the computer processor 122. In one exemplary embodiment herein, the input unit 130 is a finger or stylus to be used on a touchscreen interface of the display unit 128. The input unit 130 may alternatively be another input device such as a keyboard or stylus. In one example, the display unit 128, the input unit 130, and the computer processor 122 may collectively form a user interface 126.

One or more steps of overmolding gutta-percha 11 onto carriers 10 may be stored on a non-transitory storage device in the form of computer-readable program instructions. To execute a procedure, the processor 122 loads the appropriate instructions, as stored on a storage device, into memory and then executes the loaded instructions.

The computer system 100 of FIG. 8 may further comprise a main memory 132, which may be a random access memory (“RAM”) and also may include a secondary memory 134. The secondary memory 134 may include, for example, a hard disk drive 136 and/or a removable-storage drive 138 (e.g., a floppy disk drive, a magnetic tape drive, an optical disk drive, a flash memory drive, and the like). The removable-storage drive 138 may read from and/or write to a removable storage unit 140 in a well-known manner. The removable storage unit 140 may be, for example, a floppy disk, a magnetic tape, an optical disk, a flash memory device, and the like, which may be written to and read from by the removable-storage drive 138. The removable storage unit 140 may include a non-transitory computer-readable storage medium storing computer-executable software instructions and/or data.

In further alternative embodiments, the secondary memory 134 may include other computer-readable media storing computer-executable programs or other instructions to be loaded into the computer system 100. Such devices may include a removable storage unit 144 and an interface 142 (e.g., a program cartridge and a cartridge interface); a removable memory chip (e.g., an erasable programmable read-only memory (“EPROM”) or a programmable read-only memory (“PROM”)) and an associated memory socket; and other removable storage units 144 and interfaces 142 that allow software and data to be transferred from the removable storage unit 144 to other parts of the computer system 100.

The computer system 100 also may include a communications interface 146 that enables software and data to be transferred between the computer system 100 and external devices. Such an interface may include a modem, a network interface (e.g., an Ethernet card or an IEEE 802.11 wireless LAN interface), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 146 may be in the form of signals, which may be electronic, electromagnetic, optical or another type of signal that may be capable of being transmitted and/or received by the communications interface 146. Signals may be provided to the communications interface 146 via a communications path 148 (e.g., a channel). The communications path 148 carries signals and may be implemented using wire or cable, fiber optics, a telephone line, a cellular link, a radio-frequency (“RF”) link, or the like. The communications interface 146 may be used to transfer software or data or other information between the computer system 100 and a remote server or cloud-based storage (not shown).

One or more computer programs or computer control logic may be stored in the main memory 132 and/or the secondary memory 134. The computer programs may also be received via the communications interface 146. The computer programs may include computer-executable instructions which, when executed by the computer processor 122, cause the computer system 100 to perform the methods as described hereinafter. Accordingly, the computer programs may control the computer system 100 and other components of the device and system for modeling and visualizing a dental solution.

In another embodiment, the software may be stored in a non-transitory computer-readable storage medium and loaded into the main memory 132 and/or the secondary memory 134 of the computer system 100 using the removable-storage drive 138, the hard disk drive 136, and/or the communications interface 146. Control logic (software), when executed by the processor 122, causes the computer system 100, and more generally the apparatus 14 for concentrically molding gutta-percha 11 onto carriers 10, to perform all or some of the some of the methods described herein.

Implementation of such other hardware arrangement so as to perform the functions described herein will be apparent to persons skilled in the relevant art(s) in view of this description.

### Method for Concentrically Molding Gutta-Percha onto Carriers

Having described an apparatus 14 for concentrically overmolding Gutta-Percha 11 onto a carrier 10 reference will now be made to FIGS. 3 and 3a to 3d which show one or more stages in methods according to embodiments herein.

In a first stage of one production cycle as shown FIG. 3a, the processor 122 may ensure that the apparatus is in a predetermined quadrant/location (quadrant A). One or more carriers 10 may subsequently be injection molded wherein material for injection molding the carriers 10 may enter each mold 20 (FIG. 2) through a corresponding gate 33 (FIG. 3) of the mold 20. The material (e.g., gutta-percha) may then be injected into the cavity wherein the pins 22 may be pushed out of the cavity (partially or completely) thereby allowing the material to occupy the position of where the pin was previously located within the cavity so that the material is concentrically or substantially concentrically (+/−10%) overmolded onto the carrier 10. In an embodiment herein the mold 20 may be segmented (for example, using retractable inserts or moveable configuration of the mold 20) and the apparatus may be configured to overlay gutta percha material on the carrier 10 using the one or more segments in order to obtain overmolded gutta-percha 11 having characteristics such as dimensions (e.g shape, size, radius, thickness) that match the segments. In an embodiment herein, each segment may be used in a different stage (e.g Stages A, B, C, D etc). Herein the characteristics may be predetermined. In an embodiment, at least one segment may be spiral shaped such that an overmolded gutta percha 11 extends spirally around the carrier 10. In another embodiment, at least one segment may be cylindrically shaped such that an overmolded gutta percha 11 extends cylindrically around the carrier 10. In another embodiment, the processor 122 may control the retractable pins 22 individually to retract fully or partially such that variable radii of the overlayed gutta percha may be obtained, such as a unique radius per stage. In another embodiment individual retractable pins 22 may be controlled differently such that overmolded gutta percha may not necessarily be concentric about the carrier 10.

The processor may then rotate the apparatus 14 along with the molds 20 through a predetermined angle, for example 90° to a second quadrant, B as shown in FIG. 3b. Herein a size of the cavity of the mold 20 may be altered by the processor to produce additional space for overmolding gutta-percha 11 onto the carriers 10 and the carriers 10 may be positioned in the mold using the retractable pins 35 so that the carriers 10 are preferably evenly spaced or substantially evenly spaced from the inner walls of the mold cavity 21. A first portion of the gutta-percha 11a may be overmolded on the produced carriers 10 through gates 31. The one or more retractable pins 35 may be controlled to hold the carriers 10 in a central location such that molten gutta-percha may flow into the mold cavity 21 to be molded concentrically around a portion of the carrier 10. Flow of molten gutta-percha into the cavity 21 may cause a pressure change in the cavity, causing the retractable pin to retract out of the cavity and the molten gutta-percha to assume the created space. Herein, the gutta-percha may solidify concentrically or substantially concentrically around the carriers 10.

The apparatus may then be rotated in a predetermined manner to a third quadrant, C, as shown in FIG. 3c wherein a series of corresponding retractable pins 36 may be configured to be used to centrally position the carriers 10 in the molds 20 in order to overmold a second portion of the gutta-percha 11b onto the carriers 10. Herein, gates 31 may remain in the second quadrant B and gates 32 may be used to overmold the second portion of the gutta-percha 11b onto the carriers 10.

The apparatus may then be rotated to a fourth quadrant, D, as shown in FIG. 3d. In order to produce another/third portion of the gutta-percha 11d wherein the third portion may have a thin diameter (for example, between 0.01 to 30 mm, e.g. 0.09 mm) that may meet dimensional requirements of an overmolded carrier as used in the dental industry, a mold having a horseshoe shaped portion of the cavity 21 at one end as shown in FIG. 4 may be activated by the processor. Herein, molten gutta-percha may flow from the gates 30 to the tip 42 of the carrier 10 though both sides of the horseshoe such that the carrier tip 42 does not receive excessive pressure that may cause it to break. The retractable pins 37 may then retract and the overmolded carriers may be released for another production cycle to begin. The horseshoe portion may be subsequently trimmed off in a further step.

It will be apparent to persons skilled in the art that various changes in form and detail can be made therein (e.g., locations/quadrants of the apparatus, angles of rotation, mold shapes and the like so as to perform the functions described herein and/or to meet dimensional requirements of overmolded dental carriers) without departing from the spirit and scope of the present disclosure.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The disclosure may be embodied in other specific forms without departing from the spirit or essential attributes thereof, and it is therefore desired that the present embodiments be considered in all respects as illustrative and not restrictive. Any headings utilized within the description are for convenience only and have no legal or limiting effect.

What is claimed is:

1. A method for concentrically overmolding one or more gutta-percha materials onto one or more corresponding gutta-percha carriers in stages, the method comprising:
for each stage:
obtaining predetermined dimensions of the one or more gutta-percha materials to be overmolded onto one or more corresponding gutta-percha carriers;
altering a shape and/or size of cavities of one or more corresponding molds based on the obtained predetermined dimensions;
centrally positioning the one or more corresponding gutta-percha carriers in the one or more corresponding molds using one or more corresponding retractable pins such that the one or more corresponding gutta-percha carriers are evenly spaced or substantially evenly spaced from inner walls of said cavities; and
concentrically overmolding the one or more gutta-percha materials onto the one or more corresponding gutta-percha carriers.

2. The method according to claim 1, wherein the number of stages is based on characteristics of the corresponding gutta-percha carriers said characteristics being selected from the group consisting of length, thickness and strength.

3. The method according to claim 1, wherein a diameter of the one or more gutta-percha materials overmolded at a tip of the one or more gutta-percha carriers is between 0.01 to 30 mm.

4. The method according to claim 1, further comprising altering a shape and/or size of cavities of one or more corresponding molds through (i) retractably and/or (iv) manually changing the molds.

5. An overmolded gutta-percha carrier created by the method according to claim 1.

6. An apparatus for concentrically overmolding one or more gutta-percha materials onto one or more corresponding gutta-percha carriers in stages, the apparatus comprising:
one or more corresponding molds configured to receive one or more corresponding gutta-percha carriers;
one or more retractable pins configured to centrally position the one or more corresponding gutta-percha carriers in one or more corresponding cavities of the one or more corresponding molds such that the one or more corresponding gutta-percha carriers are evenly spaced or substantially evenly spaced from inner walls of the one or more corresponding cavities;
and a processor for each stage configured to:
obtain predetermined dimensions of the one or more gutta-percha materials to be overmolded onto the one or more corresponding gutta-percha carriers; and
concentrically overmold the one or more gutta-percha materials onto the one or more corresponding gutta-percha carriers.

7. The apparatus of claim 6, wherein the number of stages is based on characteristics of the one or more corresponding gutta-percha carriers said characteristics being selected from the group consisting of length, thickness and strength.

8. The apparatus of claim 6, wherein the one or more corresponding molds has a horseshoe-shaped cavity at one end of the one or more corresponding molds for overmolding the one or more gutta-percha materials onto a tip of the one or more corresponding gutta-percha carriers such that pressure on said tip of the one or more corresponding gutta-percha carriers is minimized.

9. The apparatus of claim 6, wherein the one or more corresponding molds is changeable.

10. The apparatus of claim 9, wherein the one or more corresponding molds includes a retractable insert.

11. The apparatus of claim 6, further comprising one or more corresponding gates at each stage configured to direct molten gutta-percha into the one or more corresponding cavities to overmold the one or more gutta-percha materials.

12. The apparatus of claim 6, wherein the one or more retractable pins are configured to be concentric around the one or more corresponding molds such that the one or more corresponding gutta-percha carriers are positioned centrally.

13. An overmolded gutta-percha carrier created by the apparatus of claim 6.

14. An apparatus for concentrically overmolding one or more gutta-percha materials onto one or more corresponding gutta-percha carriers, the apparatus comprising:
one or more corresponding molds configured to receive one or more corresponding gutta-percha carriers;
one or more retractable pins configured to centrally position the one or more corresponding gutta-percha carriers in one or more corresponding cavities of the one or more corresponding molds such that the one or more corresponding gutta-percha carriers are evenly spaced or substantially evenly spaced from inner walls of the one or more corresponding cavities;
wherein the one or more corresponding molds is constructed to seal off a predetermined portion of the one or more corresponding gutta-percha carriers such that an exposed portion of the one or more corresponding gutta-percha carriers is concentrically overmolded.

15. A method for overmolding one or more gutta-percha materials onto one or more corresponding gutta-percha carriers in stages, the method comprising:
for each stage:
obtaining predetermined dimensions of the one or more gutta-percha materials to be overmolded onto one or more corresponding gutta-percha carriers;
altering a shape and/or size of cavities of one or more corresponding molds based on the obtained predetermined dimensions;
overmolding the one or more gutta-percha materials onto the one or more corresponding gutta-percha carriers.
